(19) United States
(12) Patent Application Publication
(10) Pub. No.: US 2013/0224497 A1
(43) Pub. Date: Aug. 29, 2013

(54) SUBSTRATES WITH MULTIPLE-COLOUR PAINT FILM, AND THEIR PRODUCTION

(71) Applicants: Helge Warta, Ditzingen (DE); Peter Färber, Gartringen (DE)

(72) Inventors: Helge Warta, Ditzingen (DE); Peter Färber, Gartringen (DE)

(73) Assignee: KARL WORWAG LACK- UND FARBENFABRIK GMBH & CO. KG, Stuttgart (DE)

(21) Appl. No.: 13/638,634

(22) PCT Filed: Mar. 28, 2011
(86) PCT No.: PCT/EP11/54763

§ 371 Date: Dec. 11, 2012

(30) Foreign Application Priority Data
Apr. 1, 2010 (DE) 10 2010 014 381.2

(51) Int. Cl. B32B 38/14

(52) U.S. Cl. CPC B32B 38/14
USPC 428/423.1; 156/230

(57) ABSTRACT

A method for applying a multicolored paint system to a substrate includes (1) applying a first pigmented coating material to the substrate, (2) drying and/or curing the first pigmented coating material at a selected drying and/or curing temperature, and (3) applying a second pigmented coating material to the substrate, with partial recoating of the first pigmented coating material, wherein the second pigmented coating material is applied using a laminate including a carrier on which there is a layer of the second pigmented coating material, the layer being already cured.

### RELATED APPLICATIONS

This is a §371 of International Application No. PCT/EP2011/054763, with an international filing date of Mar. 28, 2011 (WO 2011/120940 A1, published Oct. 6, 2011), which is based on German Patent Application No. 10 2010 014 381.2, filed Apr. 1, 2010, the subject matter of which is incorporated by reference.

### TECHNICAL FIELD

This disclosure relates to a method for applying a multicolored paint system to a substrate using a plurality of pigmented coating materials, and also to painted products which can be produced by such a method.

### BACKGROUND

Application of multicolored paint systems to substrates has gained massively in significance within recent years. In the automobile sector, for example, customers are more and more often demanding products distinguished by colored trim strips or by areas marked out by different color relative to a basic color. The realization of multicolored paint systems of this kind, however, generally entails very high complexity and hence also high costs. When carrying out multiple coating operations using different colors, indeed, it is not possible to adhere to the usual sequence of OEM finishing operations. In the case of typical solid-color OEM finishes as, for example, in the solid-color OEM finishing of vehicle bodies or bodywork parts, it is usual to apply a coloring basecoat material to the substrate in question, followed by a clearcoat material. This is generally carried out in a process-controlled, timed cycle, with the individual process steps being highly automated and being notable for a very high output.

For the realization of multicolored paint systems, in contrast, the process-controlled cycle has to be interrupted following application of the coloring basecoat material. The substrate is removed from the process and one or more further color paints are then applied to the basecoat material applied initially. Before this, of course, the substrate with the basecoat material must be dried and additionally, in a further step, masked. After application of the further color paint or paints has taken place, the masking is removed. The substrates can then be returned to the processing chain described above. The next step, usually, is the concluding application of the aforementioned clearcoat material.

The procedure described above is inconvenient and time-consuming. It also brings with it further disadvantages. The reason is that conventional OEM finishing processes take place in dust-free, sealed-off coating environments. As a result of the aforementioned removal and return of the substrates, however, dust and dirt are frequently carried into the sealed-off coating environments and this may result, for example, in defects in the course of the concluding application of the clearcoat material. Addressing such defects entails further complexity and hence also further costs.

It could therefore be helpful to provide an alternative technical solution to apply a multicolored paint system to a substrate, with which the problems identified above occur not at all or only to a diminished extent.

### SUMMARY

We provide a method for applying a multicolored paint system to a substrate including (1) applying a first pigmented coating material to the substrate, (2) drying and/or curing the first pigmented coating material at a selected drying and/or curing temperature, and (3) applying a second pigmented coating material to the substrate, with partial recoating of the first pigmented coating material, wherein the second pigmented coating material is applied using a laminate including a carrier on which there is a layer of the second pigmented coating material, the layer being already cured.

We also provide a substrate having a multicolored paint system, produced or producible by the method.

### DETAILED DESCRIPTION

Our method is used, like the conventional processes mentioned above, to apply a multicolored paint system to a substrate. Substrates contemplated include more particularly bodies and bodywork parts of motor vehicles. In principle, however, any other substrates desired, such as furniture or electronic devices, for example, may be provided with a multicolored paint system by our method.

Our method always comprises the following steps:
(1) Applying a first pigmented coating material to the substrate: In this step, the substrate is given a basic color to which subsequently, one or more further colors may be applied. The pigmented basecoat material used is usually a waterborne coating material, i.e., a coating material with water as its solvent basis. In principle, however, the first pigmented coating material may also be an alternative solventborne coating material or a powder coating material.
(2) Drying and/or curing the first pigmented coating material at a drying and/or curing temperature: where the first pigmented coating material used comprises a solvent, this solvent must be removed after application of the first pigmented coating material. For this purpose, the first pigmented coating material is generally exposed to an elevated temperature (the aforementioned drying temperature). Optionally, the first pigmented coating material is also brought to a defined temperature (the aforementioned curing temperature), more particularly heated, for it to be at least partly cured, where necessary. This is relevant especially when the first pigmented coating material comprises thermally crosslinkable components. In addition, of course, the drying and/or curing step may also encompass curing by actinic radiation, more particularly with UV radiation additionally to or in lieu of the thermal curing. This is relevant especially when the first pigmented coating material comprises radiation-crosslinkable components. Preferably, the drying temperature corresponds to the curing temperature. Drying and curing may optionally take place simultaneously.
(3) Applying a second pigmented coating material to the substrate, more particularly with partial recoating of the first pigmented coating material. The second pigmented coating material differs in color from the first pigmented coating material, serving, for example, to provide the aforementioned decorative strips and/or areas marked out by different color. The first pigmented coating material, which usually covers the substrate over a large area, is preferably partly recoated with the second pigmented coating material.

Our method is notable particularly for the fact that the second pigmented coating material is applied using, instead of a conventional paint, a laminate which comprises a carrier on which there is a layer of the second pigmented coating material, this layer being already cured, hence no longer containing any radiation-crosslinkable and/or heat-crosslinkable components or any solvent. A laminate with an already-cured coating layer of this kind is relatively insensitive to heat. Unwanted blistering generally plays no part during its application.

Laminates and coating layers of these kinds are described, for example, in PCT/EP2008/006765 (WO2009/024310). They are notable in particular for the fact that the aforementioned carrier is detachable from the coating layer present on it, even if the layer has already undergone thermal and UV curing. The carrier, then, may serve only as a “transfer medium” by which a coating material can be transferred to a substrate.

This is the form of operation used herein. For application of the second pigmented coating material, the laminate is preferably pressed onto the substrate by the side on which the layer of the second pigmented coating material is disposed. The carrier is subsequently removed, then leaving the pigmented second coating layer on the substrate.

The content of PCT/EP2008/006765, more particularly all aspects relating to the coating materials and laminates described therein, are hereby incorporated by reference.

With particular preference, the second pigmented coating material is applied at a temperature which corresponds to the aforementioned drying and/or curing temperature or is even above that temperature. As mentioned, drying and/or curing of the first pigmented coating material in step (2) takes place generally at elevated temperatures. In conventional processes, such drying and/or curing is usually followed by a cooling step, since liquid coating materials, in particular, cannot be applied to heated substrates without blistering. In the context of our method, no such cooling step is mandatory and, instead, the substrate to be painted can be coated directly with the second pigmented coating material while the substrate is still at the drying and/or curing temperature.

Preferably, after the second pigmented coating material has been applied, the substrate is heat-treated at a heat-treating temperature, more particularly at a temperature of 40° C. to 180° C., more preferably 80° C. to 160° C. A heat-treating step of this kind may immediately follow application of the second pigmented coating material to the substrate which is still hot, being at the drying and/or curing temperature. Alternatively, of course, the second pigmented coating material may also be applied, however, at a temperature below the drying and/or curing temperature. In that case the heat treatment may be necessary to ensure sufficient adhesion of the layer of the second pigmented coating material to the layer of the first pigmented coating material.

Preferably, the laminate employed in our method may comprise an adhesion-promoting layer, which more particularly is disposed on the second pigmented coating layer. Preferably, therefore, the second pigmented coating layer is disposed between the adhesion-promoting layer and the carrier. On application, the laminate is then pressed, with the adhesion-promoting layer leading, onto the substrate.

The adhesion-promoting layer is preferably selected such that it is activated at a temperature which corresponds to, or even is above, the aforementioned drying and/or curing temperature or the heat-treating temperature. At room temperature, in contrast, the layer is preferably dry and nontacky. Preferably, it may enter into a durable, firm connection with the dried and/or cured first pigmented coating material only when it is heated at least to the drying and/or curing temperature or to the heat-treating temperature as, for example, when being contacted with an as yet uncooled substrate from step (2), or during the described heat-treating operation.

In the laminate used, this adhesion-promoting layer is preferably already cured, like the pigmented coating layer. Correspondingly, it preferably no longer contains any groups crosslinkable thermally or by actinic radiation. Its adhesion-promoting properties are preferably activatable exclusively by heating.

The advantages of our method are obvious. The use of the described laminate, more particularly having the adhesion-promoting layer tailored to the drying and/or curing temperature as per step (2), allows the second pigmented coating material to be applied to the first pigmented coating material without intermediate steps such as the aforementioned cooling step or the abovementioned masking of the substrate and subsequent removal of such masking. This is made possible by the fact that the laminate used can be brought into the particular desired shape by appropriate trimming even before being applied to the substrate. Even complex color patterns and color geometries can readily be applied to the substrate in this way.

Preferably, it is also possible in our method to use a laminate which comprises a layer of a second pigmented coating material that itself has adhesion-promoting properties, i.e., is able to enter into a firm bond with the first pigmented coating material without the need for a separate adhesion-promoting layer. Preferably, the adhesion properties of this layer as well can be activated at a temperature which corresponds to the aforementioned drying and/or curing temperature or is above it (it may be necessary for the laminate used and/or the substrate, heated to the drying and/or curing temperature, to be additionally heated). At room temperature, in contrast, the layer is preferably dry and nontacky.

Particularly preferably, not only a second pigmented coating material is applied to the substrate after step (2). It is of course also possible for the substrate to be recoated with one or more further pigmented coating materials. This can be done sequentially or else simultaneously with the application of the second pigmented coating material. For application of the further pigmented coating material or materials, it is preferred to use at least one further laminate, of the kind described above, i.e., a laminate with a carrier, a pigmented and already-cured coating layer present thereon and, also, optionally, an additional adhesion-promoting layer.

The abovementioned drying and/or curing temperature is preferably 40° C. to 180° C., more particularly 80° C. to 110° C. A temperature within this temperature range is generally sufficient to remove any solvent present in the first pigmented coating material and also, optionally, to cure the first pigmented coating material.

Adhesion-promoting layers which can be activated by heating to such a drying and/or curing temperature are known. In the context of our method, it is particularly preferred for the adhesion-promoting layer used to be a layer of adhesive based on polyurethanes, more particularly based on a poly-urethane dispersion. This is so especially when the first pigmented coating material as well is based on a polyurethane, more particularly on a polyurethane dispersion, or has been prepared at least proportionally from such a dispersion.

As a pigmented second coating material, the laminates used in our method preferably likewise have a polyurethane-based coating layer. With particular preference, here as well, a coating material comprising a polyurethane dispersion is used. Suitability is possessed, for example, by polyester-based polyurethane dispersions. This is the case likewise especially when the first pigmented coating material as well is based on a polyurethane, more particularly on a polyurethane dispersion, or has been prepared at least proportionally from such a dispersion.

Also suitable are the coating layers described in PCT/EP2008/006765 as well, composed of a coating material comprising a double-bond-containing, OH-functional component A and a double-bond-containing, NCO-functional component B, with component A preferably having a solids fraction of 30% to 100% by weight, a double-bond density of 2 eq/kg to 5 eq/kg (at a solids fraction of 100%), and an OH content of 4% to 7% by weight. Component B is generally characterized by a solids fraction of 30% to 100% by weight, a double-bond density of 1 eq/kg to 4 eq/kg (at a solids fraction of 100%), and an NCO content of 4% to 7% by weight. As mentioned above, with regard to preferred features and properties of such a coating material, reference is made to PCT/EP2008/006765.

Reference may also be made to PCT/EP2008/006765 with regard to suitable carriers. The carrier is preferably a film, more particularly a single-layer film or a multilayer composite film. Suitability is possessed in principle by all films having release properties, more particularly having release properties for polyurethane-based adhesives and coating materials.

The carrier preferably consists substantially of polymeric material, more particularly of fluoropolymers such as ethylene-tetrafluoroethylene (ETFE), polyethylene terephthalate, polyolefin, polycarbonate, acrylonitrile-butadiene-styrene (ABS), acrylic-styrene-acrylonitrile (ASA), acrylonitrile-butadiene-styrene/polycarbonate (ABS/PC), acrylic-styrene-acrylonitrile/polycarbonate (ASA/PC), polyacrylate, polystyrene, polycarbonate/polybutylene terephthalate (PC/PBT) and/or polymethyl methacrylate.

With particular preference, a laminate used in our method has a carrier composed of a biaxially oriented polypropylene film or of a biaxially oriented polyethylene terephthalate film.

The first pigmented coating material is preferably a polyurethane-based coating material, more particularly a liquid coating material. The first pigmented coating material and the second pigmented coating material and/or, optionally, the adhesion-promoting layer are preferably tailored chemically to one another, thus ensuring optimum adhesion of the second pigmented coating material to the first pigmented coating material.

Prior to application of the first pigmented coating material it is possible, optionally, for an anticorrosion primer to be applied to the substrate. Anticorrosion primers of this kind are known and need not be elucidated further.

The same also applies to the clearcoat material, which may be applied to the substrate, optionally, after step (3). Such a clearcoat material is generally a liquid coating material.

Particularly preferably, the laminate is thermoformed before it is used to recoat the first pigmented coating material. This thermoforming may be preferable especially when the substrate to be coated has a nonplanar surface to which the second pigmented coating material and/or one of the further pigmented coating materials is to be applied. The thermoforming of laminates, as described in PCT/EP2008/006765 and used herein are readily possible, provided that thermoformable films are used as carriers. With regard to possible film materials, reference is made to the statements above.

The thermoforming operation on the laminate may take place optionally before final curing of the pigmented coating material present on the carrier. Since the laminate is generally heated during thermoforming, the coating material may possibly undergo thermal curing during the thermoforming operation. After thermoforming (but before application of the laminate), the final curing of the coating material may then take place, by actinic radiation, for example.

Substrates provided with a multicolored paint system and producible by our method or produced by such a method are likewise provided. As mentioned above, such substrates may basically be any possible, conceivable industrial products. Preferably they are automobile bodies or parts thereof.

Further features of our method will emerge from the example in conjunction with the appended claims. It is expressly emphasized at this point that all of the optional aspects of our method or of the substrate that are described herein may be actualized each on their own or in combination with one or more of the further optional aspects described, in the method. The description below of preferred examples serves solely for elucidation and for better understanding, and should in no way be understood to impose any restriction.

### EXAMPLE

A laminate was produced by mixing 250 parts by weight of filler paste with 20 parts by weight of butyl glycol, 50 parts by weight of demineralized water, 305 parts by weight of polyurethane dispersion, and 20 parts by weight of polyester polyol emulsion. The resulting mixture was stirred for five minutes, after which 320 parts by weight of pigment paste, 25 parts by weight of polyester polyol emulsion and, for viscosity adjustment, a further 10 parts by weight of demineralized water were added. The resulting paint mixture was then aged for 16 hours, after which its pH was adjusted with dimethylethylamine (DMEA) to a value of between 8 and 9.

Following provision of a biaxially oriented polyethylene terephthalate film, the paint mixture prepared was knife-coated onto one side of this film, and then cured at elevated temperatures.

With a laminate produced in this way it was possible without problems to recoat a substrate coated with a first pigmented coating material. For this purpose, after the application of the first pigmented coating material, the substrate was dried at a temperature of around 110° C. Immediately after the drying, the laminate produced was applied, with the paint side leading, to the still-hot layer of the first coating material. Following application, the polyethylene terephthalate film was readily removable.

The film was also readily removable if the laminate was applied to a coating material, this coating material having been dried at between 60° C. and 70° C. and then cooled to room temperature, and the laminate was subsequently heat-treated at 120° C. to 140° C. for a short time.

1. A method for applying a multicolored paint system to a substrate comprising:
(1) applying a first pigmented coating material to the substrate,
(2) drying and/or curing the first pigmented coating material at a selected drying and/or curing temperature, and
(3) applying a second pigmented coating material to the substrate, with partial recoating of the first pigmented coating material,
wherein the second pigmented coating material is applied using a laminate comprising a carrier on which there is a layer of the second pigmented coating material, the layer being already cured.

2. The method as claimed in claim 1, wherein applying the second pigmented coating material takes place at a temperature which corresponds at least to the drying and/or curing temperature.

3. The method as claimed in claim 1, wherein the substrate, after applying the second pigmented coating material, is heat-treated at a heat-treating temperature of 40° C. to 180° C.

4. The method as claimed in claim 1, wherein the laminate comprises an adhesion-promoting layer.

5. The method as claimed in claim 4, wherein the adhesion-promoting layer is selected such that it is activated at the drying and/or curing temperature or at the heat-treating temperature.

6. The method as claimed in claim 1, wherein, after step (2), as well as the second pigmented coating material, at least one further pigmented coating material is applied to the substrate using at least one further laminate which comprises a carrier on which there is a layer of an already-cured pigmented coating material.

7. The method as claimed in claim 1, wherein the drying and/or curing temperature is 40° C. to 180° C.

8. The method as claimed in claim 1, wherein a layer of adhesive based on polyurethane is used as adhesion-promoting layer.

9. The method as claimed in claim 1, wherein the laminate comprises as a second pigmented coating layer a coating layer based on polyurethane.

10. The method as claimed in claim 1, wherein the layer of adhesive and/or the second pigmented coating layer in the laminate has been cured thermally and/or with UV radiation.

11. The method as claimed in claim 1, wherein an anticorrosion primer is applied to the substrate before step (1).

12. The method as claimed in claim 1, wherein a clearcoat material is applied to the substrate after step (3).

13. The method as claimed in claim 1, wherein the laminate is thermoformed before being used.

14. A substrate having a multicolored paint system, produced or producible by the method as claimed in claim 1.
